(19) United States
(12) Patent Application Publication
(10) Pub. No.: US 2024/0418183 A1
(43) Pub. Date: Dec. 19, 2024

(54) CENTRIFUGAL PUMP FOR CONVEYING A FLUID

(71) Applicant: Sulzer Management AG, Winterthur (CH)

(72) Inventors: Daniele CIMMINO, Figino (CH); Stefan BERTEN, Winterthur (CH)

(21) Appl. No.: 18/670,552

(22) Filed: May 21, 2024

(30) Foreign Application Priority Data
Jun. 14, 2023 (EP) 23179343.1

(51) Int. Cl. F04D 29/42; F04D 29/28; F04D 29/44

(52) U.S. Cl. CPC F04D 29/428; F04D 29/281; F04D 29/444

(57) ABSTRACT

A centrifugal pump includes a pump casing having a central axis defining an axial direction, a pump chamber, an impeller arranged within the pump chamber and rotatable about the axial direction, a discharge passage for discharging the fluid from the pump chamber, and a tongue for guiding the fluid to the discharge passage. The tongue includes an inner surface facing the central axis, an outer surface facing away from the central axis, and a leading edge joining the inner surface and the outer surface. The tongue includes a flow passage extending from the inner surface through the tongue to the outer surface.

### CROSS-REFERENCE TO RELATED APPLICATION

This application claims priority to European Application No. 23179343.1, filed Jun. 14, 2023, the contents of which are hereby incorporated by reference in its entirety.

### BACKGROUND

The disclosure relates to a centrifugal pump for conveying a fluid.

### TECHNICAL FIELD

Conventional centrifugal pumps for conveying a fluid, for example a liquid such as water, are used in many different industries. Examples are the oil and gas industry, the power generation industry, the chemical industry, the water industry or the pulp and paper industry. Centrifugal pumps have at least one impeller and a pump shaft for rotating the impeller. The at least one impeller can be configured for example as a radial impeller or as an axial or semi-axial impeller or as a helico-axial impeller.

### BACKGROUND INFORMATION

A centrifugal pump can be designed as a single stage pump having only one impeller mounted to the shaft or as a multistage pump comprising a plurality of impellers, wherein the impellers are arranged one after another on the shaft. Each of the impellers is arranged in a pump chamber. The pump chamber is that part of the pump, in which the impeller rotates. The impellers can be arranged in an in-line arrangement, where the axial thrust generated by a single impeller is directed in the same direction for all impellers, or in a back-to-back arrangement, where the axial thrust generated by a first group of impellers is directed in the opposite direction as the axial thrust generated by a second group of impellers.

### SUMMARY

A centrifugal pump can be configurated as a volute type pump, wherein the pump chamber is configured as a volute chamber, or as a diffuser type pump wherein the pump casing comprises a diffuser surrounding the pump chamber and having a plurality of stationary diffuser vanes.

It has been determined that when the pump chamber is configured as a volute chamber, the distance between the inner wall delimiting the volute chamber and the central axis of the pump housing increases when viewed in the flow direction towards the discharge passage, through which the fluid leaves the volute chamber. A tongue separates the beginning to the discharge channel from the volute chamber. At the tongue the radial distance of the impeller from the inner wall delimiting the volute chamber is smallest. The tongue in a volute type pump is also referred to as cutwater, cutwater tongue or splitter rib. It is also known to design a volute type pump with two cutwaters, which are displaced by approximately 180° relative to each other when viewed in the circumferential direction of the volute chamber.

In a diffuser type pump, the pump chamber is typically configured as a circular pump chamber. A plurality of discharge passages is provided, each of which is arranged between and limited by two adjacent stationary diffuser vanes. Thus, the leading edge of each diffuser vane constitutes a tongue separating the beginning of a discharge channel from the pump chamber.

Thus, the volute type pump and the diffuser type pump have in common at least one tongue that is provided at a discharge passage that leaves the pump chamber. Within the framework of this application the term tongue is used both for referring to the cutwater in a volute type pump and to the leading edge of a stationary diffuser vane in a diffuser type pump.

Nowadays in many applications the most efficient use of the pump is strived for. It is desirable to have the highest possible ratio of the power, especially the hydraulic power, delivered by the pump to the power needed for driving the pump. This desire is mainly based upon an increased awareness of environment protection and a responsible dealing with the available resources as well as on the increasing costs of energy. Therefore, all pumps regardless of their configuration are sized and optimized to work at or near the best efficiency point (BEP). The BEP is that point in a pump head curve where the efficiency of the pump is the highest.

The diagram in FIG. 1 illustrates three different pump head curves H₁, H₂ and H₃ for the relationship between the head H of the pump and the flow Q delivered by the pump, i.e. in FIG. 1 the flow Q is plotted against the head H. Three different curves are shown in FIG. 1. The curve H₁ indicates a well-defined relationship, where each head belongs to exactly one flow and vice versa. The curve H1 starts at the point, where there is no flow (also known as shutoff head) and gradually drops until it reaches the point of maximum flow (also known as runout point). The BEP (not shown) is generally located at 80% of the maximum flow of the curve H1.

The curves H₂ and H₃ show pump head curves with instabilities at part load flows. The relationship between the head H and the flow Q is no longer biunique. There are values for the head H, for which at least two or even three different values of the flow Q exist.

This can result in instabilities such as saddle instabilities or droop to shut-off instabilities. Curve H₂ shows a pump head curve with a saddle instability. Curve H₃ shows a droop to shut-off instability.

For a variety of centrifugal pumps such pump head curve instabilities have been observed. The modifications or redesign rules needed to avoid such behavior are difficult to determine and can vary depending on the type of pump. The performance instability only becomes apparent once the pump has been tested. Any change at this stage could lead to a massive increase in cost and lead time.

When operating the pump at or near the BEP the absolute inlet flow angle usually referred to as α₃ is at an optimum. This angle α₃ describes the direction of the flow of the fluid to be pumped against the leading edge of the tongue. During normal operation of the pump at or near the BEP the angle α₃ has an optimal value so that the incident fluid is smoothly and deficiently guided around the tongue into the discharge passage.

In everyday use of the pumps, it is possible that the pump is not operated at the BEP because of e.g. a reduction in flow rate due to the development of adverse inlet conditions or intentionally caused by the user for example, because the demand for the fluid to be pumped is lower. Therefore, the pump can be operating in the low flow region of the pump head curve. At reduced flow rates, i.e. away from the BEP, the absolute inlet flow angle α₃ changes and typically decreases with decreasing flow. This leads to stall and turbulence, in particular in the discharge passage. The kinetic energy of the fluid which exits the volute chamber or the diffuser through the discharge passages, is considerably reduced in particular in those regions of the discharge passage which are adjacent to the tongue. This decreased boundary layer flow can result in stall and the generation of turbulences, which causes a decrease in the overall performance of the pump. This problem exists in an analogous manner both in volute type pumps and in diffusor type pumps.

Starting from this state of the art it is therefore an object of the disclosure to propose a centrifugal pump which has an increased stability of the pump head curve at low flows.

The subject matter of the disclosure satisfying these objects is characterized by the features disclosed herein.

Thus, according to the disclosure a centrifugal pump for conveying a fluid is proposed, comprising a pump casing having a central axis defining an axial direction, a pump chamber, an impeller arranged within the pump chamber and configured for rotating about the axial direction, at least one discharge passage for discharging the fluid from the pump chamber, and at least one tongue for guiding the fluid to the discharge passage, wherein the tongue comprises an inner surface facing the central axis, an outer surface facing away from the central axis, and a leading edge joining the inner surface and the outer surface. The tongue comprises at least one flow passage, which extends from the inner surface through the tongue to the outer surface.

Providing the at least one flow passage in the tongue, results in a flow of the fluid from the inner surface across the tongue to the outer surface of the tongue. The flow supplies additional kinetic energy to the fluid in the discharge channel. In particular, this additional kinetic energy is delivered to the boundary layers of the fluid next to the outer surface of the tongue. This at least partially compensates the energy loss in the boundary layers of the fluid in the discharge passage at low flows. The fluid injected through the flow passage or the flow passages re-energizes in particular the fluid in the boundary layers at the outer surface of the tongue, i.e. in the discharge passage, where stall were likely to occur. By the fluid injected through the flow passage(s) the occurrence of stall is at least considerably suppressed, so that instabilities in the pump performance are strongly reduced or avoided. The pump head curve looks qualitatively like the curve H1 in FIG. 1.

Thus, the part of the fluid that flows through the flow passage(s) in the tongue (also referred to as bypass flow) passes through the flow passage(s) without major energy loss and subsequently releases energy to the flow in the discharge passage (also referred to as mainstream flow) particularly to the boundary layers of the mainstream flow at the outer surface. This leads to an increase in kinetic energy in the mainstream flow and at the same time to a suppression of stall in the discharge passage. Therefore, the overall pump performance is improved by the energizing the boundary layer flow.

An important advantage of the at least one flow passage is that the pattern, the shape and the number of the flow passages can be adjusted depending on the specific pump or the specific operational parameters or the specific application or the type of the observed instability. Thus, it is possible to configure tongues or to adapt tongues with such a flow passage or with such flow passages for different applications. Instabilities can easily be removed without larger constructional effort, even after the pump has been tested. As a further advantage of the flow passage(s) it has been noticed that the flow passage(s) can be provided without affecting the pump performance at or near the BEP, i.e. at partial load or low flows the at least one flow passage reliably prevents or at least considerably reduces instabilities, but at or near the BEP the flow passage or the flow passages have no or at most a negligible influence on the pump performance. This is very advantageous, since in most cases the pump is predominantly operated at or near the BEP.

Another important advantage of implementing at least one flow passage in the tongue is that in the event of instabilities of the pump head curve at low flow, no major changes need to be made to the pump to obtain an increase in the pump performance at low flow compared to other solution approaches, such as replacing pump parts. This not only avoids pump downtime, but also eliminates the need for skilled personnel to rebuild the pump. This of course saves considerable costs. From a cost perspective, there is a massive saving compared to redesigning components.

The configuration with the at least one flow passage in the tongue can be used for all types of centrifugal pumps for example in a single stage pump or a multistage pump. In particular, the configuration can be used both for diffuser type pumps and for volute type pumps, but also for other type of pumps having at least one tongue for guiding the fluid from the pump chamber to a discharge passage.

In some embodiments the pump casing comprises a plurality of tongues and a plurality of discharge passages, wherein each tongue is configured for guiding the fluid in one of the discharge passages, and wherein each tongue comprises at least one flow passage, which extends from the inner surface through the tongue to the outer surface of the tongue.

In some embodiments the pump chamber is configured as a volute chamber. This includes the possibilities that the volute chamber is configured with exactly one tongue (cutwater) and one discharge passage or with more than one tongues (cutwaters) and more than one discharge passage. In particular, the volute chamber can be configured with exactly two tongues (cutwaters) and two discharge passages. The two tongues are preferably displaced by approximately 180° relative to each other when viewed in the circumferential direction of the volute chamber.

In other embodiments the pump casing comprises a diffuser surrounding the pump chamber and having a plurality of stationary diffuser vanes, each of which comprises one of the tongues for directing the fluid in one of the discharge passages.

It is an advantageous measure that each tongue comprises a plurality of flow passages, each of which extends from the inner surface through the tongue to the outer surface of the tongue.

Preferably, each discharge passage has an entrance area, which is the cross sectional area of the discharge passage at the leading edge of the tongue delimiting the discharge passage, wherein the total flow cross-section of all flow passages provided in the respective tongue is at least 8% and at most 45% of the entrance area, preferably at most 30% and particularly preferred at most 20% of the entrance area.

In addition, it is preferred, that for each tongue all flow passages are arranged in an angular region which is delimited by a leading edge tangent from the central axis to the leading edge and a straight borderline from the central axis to the tongue, wherein the leading edge tangent and the borderline include an angle from 2° to 20°. In particularly preferred embodiments the angle is between 10° to 20°. The borderline and the leading edge tangent lie in a common plane, which is perpendicular to the axial direction. When the flow passage(s) of the respective tongue is/are arranged in the angular region adjacent to the leading edge of the tongue, the pressure drop over each flow passage, i.e. the pressure difference between the pressure prevailing at the inner surface and the pressure prevailing at the outer surface of the tongue is in any case large enough to generate a strong flow of fluid through the flow passage and an injection of the fluid into the discharge passage at the outer surface of the tongue.

Furthermore, it is advantageous, when each flow passage is configured as a straight passage obliquely extending with respect to the leading edge tangent of the respective tongue. The oblique design has the advantage that the energy input added from the bypass flow to the mainstream flow is better. The straight passage design is easier to produce and therefore more cost-effective.

Preferably, each flow passage is configured to have an inclination angle, which is the angle between the flow passage and the inner surface of the tongue at a location, where the distance of the inner surface from the central axis is minimal, wherein the inclination angle is preferably between −45° to 45°.

The optimum inclination angle depends on the specific pump, or the specific application, respectively. Depending on the angle at which the fluid flows against the leading edge of the tongue, the flow passage(s) can be adjusted to the specific conditions in advance to ensure efficient performance of the pump.

In some embodiments, at least one flow passage is configured as a closed passage, e.g. a channel, extending inside the tongue. The term “closed passage” shall be understood as a passage which is completely closed on all sides or along the entire circumference, respectively, so that the inlet to the passage and the outlet from the passage are the sole openings through which a fluid can enter or leave the passage. In contrast, an “open passage” designates a passage, which is not limited by a wall in a direction vertical to its main direction of flow, thus in a direction vertical to its longitudinal extension, but it is open. So, for example, a passage with an U-shaped or a V-shaped wall is an open passage. If the open side of the U-profile or of the V-profile were covered with a plate, the passage would be a closed passage.

It is also possible that at least one flow passage is configured as an open passage, preferably as a groove.

These two configurations of an open flow passage and a closed passage, respectively, can be manufactured for example by machining methods, such as drilling or milling. It is also possible to chemically etch the passages into the tongue.

According to a preferred configuration, at least two flow passages are arranged in a first row extending in the axial direction, wherein the first row comprises at most six flow passages.

Furthermore, it is a preferred configuration, that at least two flow passages are arranged in a second row extending perpendicular to the axial direction, wherein the second row comprises at most six flow passages.

According to a further preferred configuration, each tongue comprises a plurality of flow passages, wherein the flow passages are arranged in the form of a matrix. Preferably, the matrix has a maximum number of three rows and three columns, so that the matrix is at most 6×6 matrix.

Further advantageous measures and embodiments of the disclosure will become apparent from the dependent claims.

### BRIEF DESCRIPTION OF THE DRAWINGS

The disclosure will be explained in more detail hereinafter with reference to the drawings.

FIG. 1 illustrates a diagram with three different pump head curves,

FIG. 2 illustrates a cross-sectional view of a first embodiment of a centrifugal pump according to the disclosure,

FIG. 3 illustrates a cross-sectional view of the first embodiment in a section perpendicular to the axial direction,

FIG. 4 illustrates a cross-sectional view similar to FIG. 3, but for a second embodiment of a centrifugal pump according to the disclosure,

FIG. 5 illustrates a cross-sectional view of a section of the tongue of the first embodiment,

FIG. 6 illustrates an enlarged view of the tongue shown in FIG. 5,

FIG. 7 illustrates a perspective view of a first variant for the tongue, and

FIG. 8 illustrates a schematic view on a second variant for the tongue.

### DETAILED DESCRIPTION

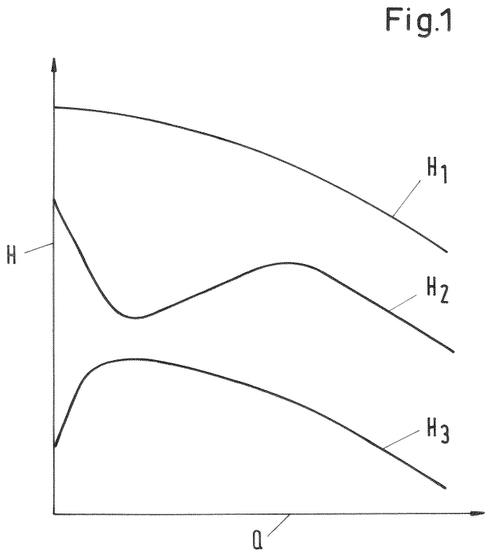

FIG. 1 illustrating the diagram with the three pump head curves H1, H2, H3 has already been discussed in the introduction, so that further comments regarding FIG. 1 are not required.

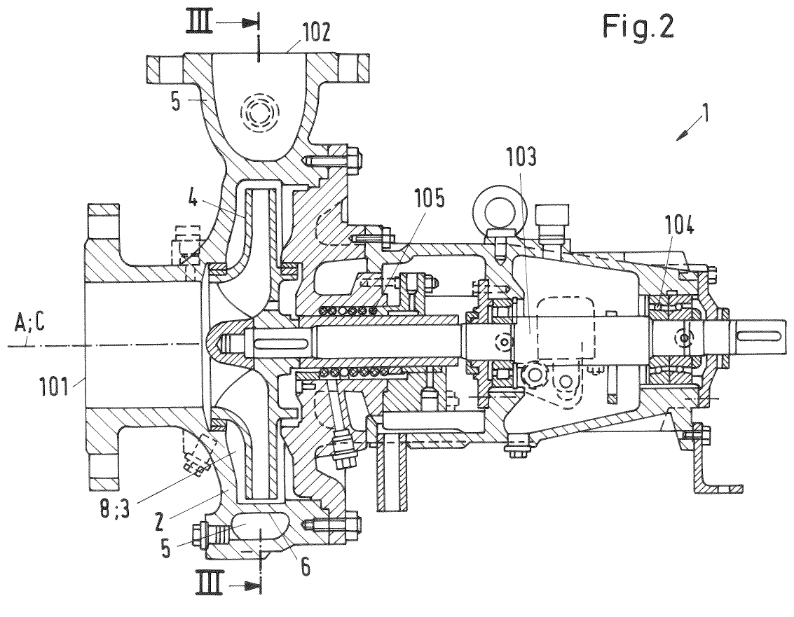

FIG. 2 is a cross-sectional view of a first embodiment of a centrifugal pump according to the disclosure, which is designated in its entity with reference numeral 1, and which comprises a pump casing 2. The centrifugal pump 1 comprises an inlet 101, through which a fluid, in particular a liquid, for example water, can enter the pump 1 as well as an outlet 102 for discharging the fluid. The pump 1 further comprises at least one impeller 4 for acting on the fluid. The impeller 4 is arranged within a pump chamber 3 of the pump casing 2. During operation the impeller 4 is rotating about a rotational axis defining in an axial direction A. The pump casing 2 comprises a central axis C coinciding with the rotational axis of the pump 1. Thus, the axial direction A is defined by the central axis C of the pump casing 2 or—what is the same—by the rotational axis about which the impeller 4 rotates during operation.

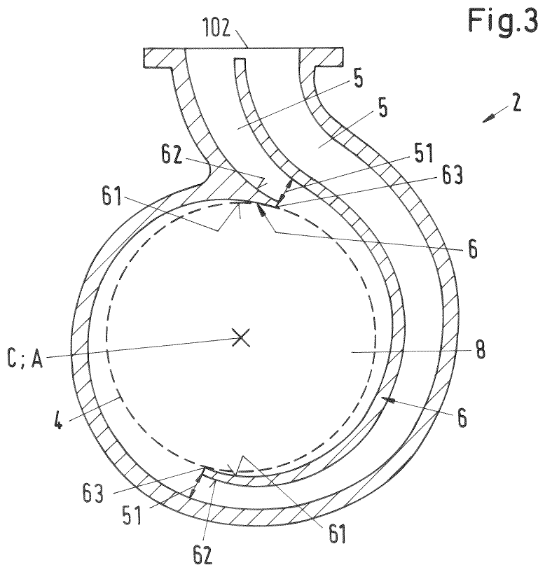

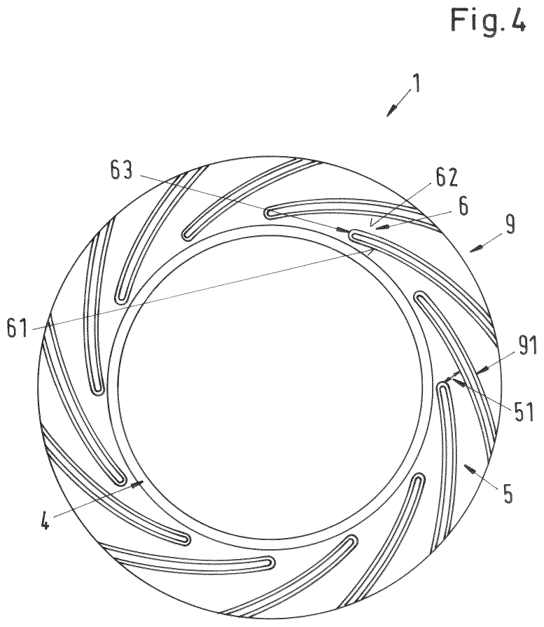

In the following, reference is made to two different pump types, namely the volute type pump and the diffusor type pump. Volute type refers to a pump 1, in which the pump chamber 3 is designed as a volute chamber 8. Such a design is shown in FIG. 2 and FIG. 3. In the diffusor type pump, the pump chamber 3 is surrounded by a diffusor 9. Such a configuration is shown in FIG. 4.

A direction perpendicular to the axial direction A is referred to as ‘radial direction’. The term ‘axial’ or ‘axially’ is used with the common meaning ‘in axial direction’ or ‘with respect to the axial direction’. In an analogous manner the term ‘radial’ or ‘radially’ is used with the common meaning ‘in radial direction’ or ‘with respect to the radial direction’.

FIG. 2 illustrates the pump 1 in a cross-section parallel to the axial direction A, more precisely the central axis C lies in the section plane. The impeller 4 is mounted on a shaft 103 in a torque proof manner. By the shaft 103 extending in axial direction A the impeller 4 is driven during operation of the pump 1 for a rotation about the axial direction A. The shaft 103 is driven by a drive unit (not shown), for example an electric motor or any other type of motor, to which the shaft 103 is coupled. In a manner known as such the shaft 103 and the impeller 4 are supported by a bearing unit 104. A sealing unit 105 seals the shaft 103 against leakage of the fluid along the shaft 103.

FIG. 3 illustrates a cross-sectional view of the first embodiment of the pump 1 in a section perpendicular to the axial direction A as it is indicated by the cutting line III-III in FIG. 2. Here, the pump chamber 3 is configured as the volute chamber 8. The pump casing 2 comprises the volute chamber 8 for receiving the impeller 4 and a discharge passage 5 for guiding the fluid to the outlet 102. The flow of liquid coming from the inlet 101 enters the volute chamber 8 generally in axial direction A and is then diverted by the impeller 4 in a circumferential direction. As it is characteristic for a volute chamber 8, the distance between the inner wall delimiting the volute chamber 8 and the central axis C of the pump casing 2 is increasing when viewed in the flow direction towards the discharge passage 5, thus building a flow channel for the fluid, which flow channel is widening in flow direction. The pump casing 2 further comprises at least one tongue 6 for directing the liquid into the discharge passage 5, i.e., the tongue 6 divides the flow channel such that the liquid is flowing along both sides of the tongue 6. The tongue 6 is also referred to as splitter rib or as cutwater tongue or as a cutwater.

The first embodiment shown in FIG. 3 is configured with two tongues 6. The tongues 6 are arranged at locations which are 180° displaced with respect to each other, when viewed in the circumferential direction of the volute chamber 8. The design with two tongues 6 as such is known in the art and therefore does not require a more detailed explanation. The main reason for providing two tongues 6 in the pump casing 2 is the balancing of the radial thrust acting upon the impeller 4.

Although the embodiment described here, comprises two tongues 6, it has to be understood that the disclosure also comprises such embodiments, in which the pump casing 2 is designed with only one tongue 6.

Each tongue 6 comprises an inner surface 61 facing the central axis C, an outer surface 62 facing away from the central axis C and a leading edge 63 which is the axially extending edge of the tongue 6 facing the flow of fluid, i.e. at the leading edge 63 the flow of fluid is split. The leading edge 63 constitutes the upstream end of the tongue 6. Thus, the inner surface 61 of the respective tongue 6 is that lateral surface of the tongue 6 which is closer to the central axis C and the outer surface 62 of the respective tongue 6 is that lateral surface of the tongue 6 which is farer away from the central axis C. The leading edge 63 is joining the inner surface 61 and the outer surface 62. Each of the discharge passages 5 has an entrance area 51, which is the cross-sectional area of the discharge passage 5 at the leading edge 63 of the tongue 6 delimiting the discharge passage 5. The entrance area 51 is also referred to as throat area or narrowest area of the passage 5. The entrance area 51 is that area of the discharge passage 5 adjacent to the leading edge, where the flow cross-section of the discharge passage 5 has its minimum value.

FIG. 4 illustrates a cross-sectional view similar to FIG. 3, but of a second embodiment of a centrifugal pump 1 according to the disclosure. The second embodiment is configured as a diffuser type pump 1 comprising a diffuser 9 surrounding the pump chamber 3 and having a plurality of stationary diffuser vanes 91 each of which comprises one tongue, or leading edge, 6 for directing the fluid in one of the discharge passages 5. Each discharge passage 5 is arranged between two adjacent diffuser vanes 91 and has the entrance area 51, which is the cross-sectional area of the discharge passage 5 at the leading edge 63 of the tongue 6 delimiting the discharge passage 5. Likewise, each of the tongues 6 has the inner surfaces 61 and the outer surface 62 as already described and explained with respect to the first embodiment. Different from the volute chamber 8 of the first embodiment, the pump chamber 3 of the second embodiment, i.e. the diffuser type pump 1, has a circular cross-section perpendicular to the axial direction A. In the center of the diffuser 9, the impeller 4 is schematically shown with two circles.

It goes without saying that the reference numerals apply to each diffuser vane 91 or tongue 6 shown in FIG. 4.

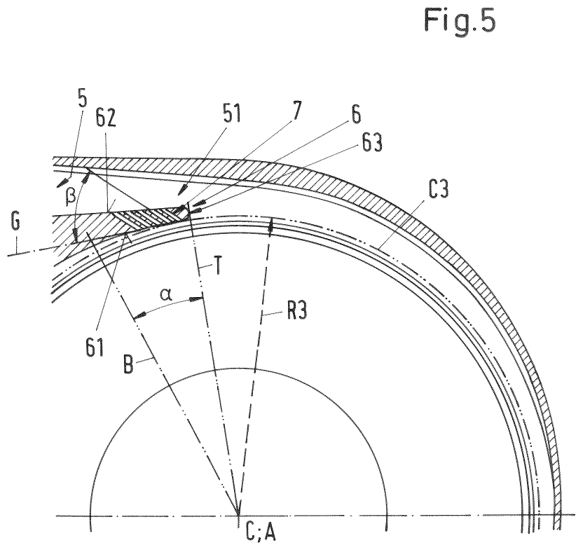

FIG. 5 illustrates a cross-sectional view of a section of the tongue 6, which is either the tongue 6 of a volute type pump (first embodiment, FIG. 3) or one of the tongues 6 of a diffuser type pump (second embodiment, FIG. 4). The configuration of the tongue 6 for the volute type pump can be the same or analogous to the configuration of the tongue 6 for the diffuser type pump.

Thus, the following description of the configuration of the tongue 6, which is made by way of example with reference to the volute type pump according to the first embodiment, applies analogously to the diffusor type pump according to the second embodiment.

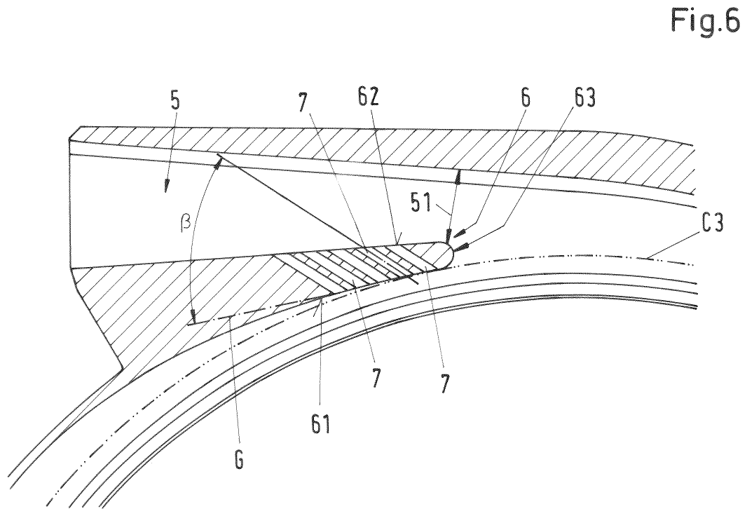

For a better understanding, FIG. 6 illustrates an enlarged view of the tongue 6 illustrated in FIG. 5.

According to the disclosure, the tongue 6 comprises at least one flow passage 7, which extends from the inner surface 61 of the tongue 6 through the tongue 6 to the outer surface 62. The embodiment of the tongue 6 in FIG. 5 and FIG. 6 includes five flow passages 7, each of which extends across the tongue 6 and constitutes a flow connection between the inner surface 61 and the outer surface 62, the flow connection being arranged in the tongue 6. The flow passages 7 are arranged parallel to each other.

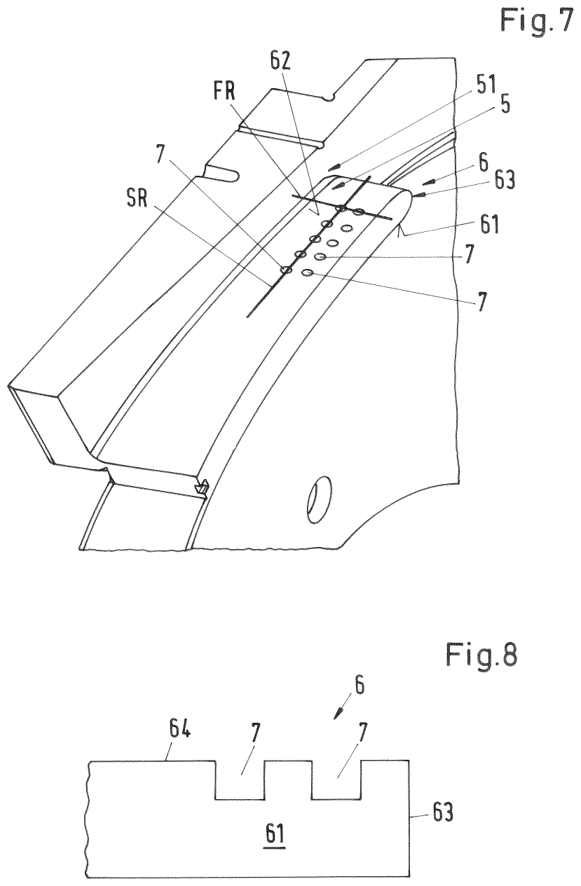

The number of five flow passages is exemplary, only. In other embodiments the tongue 6 can have fewer flow passages 7 for example only one flow passage 7 or only two flow passages 7. In still other embodiments, the tongue 6 can be configured with more than five flow passages 7 as it is shown for example, in FIG. 7.

During operation of the pump 1, the pressure prevailing at the inner surface 61 is usually higher than the pressure prevailing at the outer surface 62, at least in the region adjacent to the leading edge 6 of the tongue 6. Due to pressure difference the fluid streams from the inner surface 61 through the flow passages 7 to the outer surface 62 of the tongue 6. Thereby, fluid jets were generated, which transport energy, in particular kinetic energy from the inner surface 61 to the outer surface 62 of the tongue 6. The energy is in particular delivered to the boundary layers of the fluid at or next to the outer surface 62. Thus, the boundary layers of the fluid are re-energized by the jets of fluid leaving the flow passages 7. Due to this re-energization stall, turbulences or vortex buildup is reliably prevented or at least considerably reduced.

The appropriate number of flow passages 7, the appropriate configuration of the flow passages 7 and the appropriate arrangement of the flow passage(s) 7, of course, depends on the specific centrifugal pump 1 or the pumping system or the specific application, for which the pump 1 is used. For a skilled person, it is no problem to provide the appropriate flow passage(s) 7 for a specific pump 1 and/or application.

Practical experience has shown, that it is advantageous for many applications, when the total flow cross-section of all flow passages 7, i.e. the sum of the flow cross-sections of the individual flow passages, in the tongue 6 is at least 8% and at most 45% of the entrance area 51. As already explained the entrance area 51, which is also called throat area, is the flow cross-section of the respective discharge passage 5 at the entrance of the discharge passage, i.e. at the leading edge 63 of the tongue 6 delimiting the respective discharge passage 5.

Furthermore, practice has revealed, that it is advantageous, to arrange all flow passages 7 in a region adjacent to the leading edge 63 of the respective tongue 6. The preferred region for the flow passage(s) 7 can be described as an angular region, which is delimited by two straight lines, namely a leading edge tangent T and a straight borderline B. Both straight lines B, T lie in a common plane, which is perpendicular to the axial direction A.

The leading edge tangent T is the tangent from the central axis C to the leading edge 63, and the straight borderline B is a straight line from the central axis C to the inner surface 61 of the tongue 6. The borderline B and the leading edge tangent T include an angle α, which is preferably at least 2° and at most 20°.

Thus, the preferred region, in which all flow passages 7 are arranged, more precisely all openings of the flow passages 7 in the inner surface 61 of the tongue 6 are arranged, is defined by the angular region delimited by the leading edge tangent T and the borderline B, wherein the angle α between the two lines B, T is at least 2° and at most 20°.

Furthermore, based on practical experience and because of a very simple manufacturing it is preferred that each flow passage 7 is configured as a straight flow passage 7. In addition it is preferred, as it is shown in FIG. 5 and FIG. 6 each flow passage 7 is configured as a straight passage 7 obliquely extending with respect to the leading edge tangent T of the tongue 6.

Preferably, each flow passage 7 is configured to have an inclination angle β, which is the angle between the straight flow passage 7 and the inner surface 61 of the tongue 6 at a location, where the distance of the inner surface 61 from the central axis C has the minimal value. This distance is denoted by R3 in FIG. 5. The distance R3 defines the radius of a circle C3 having its center on the central axis C and being tangent to the tongue 6. The diameter of this circle C3 is also known to the skilled person as D3. D3 is the usual designation for the diameter of the diffuser vane leading edge for a diffuser type pump (second embodiment, FIG. 4) or the diameter of the volute cutwater for a volute type pump (first embodiment, FIG. 3).

Since the circle C3 is tangent to the tongue 6, the circle C3 and the tongue 6 have only one common point, namely that point, where the circle C3 touches the tongue 6, The straight line G shown in FIG. 5 and FIG. 6 is the tangent to the circle C3 at this common point, where the Circle C3 touches the tongue 6. The inclination angle β is the angle between the straight flow passage 7 and the straight line G. Preferably, the inclination angle β is between −45° to 45°. A positive inclination angle 0°<β≥45° means that the opening of the respective flow passage 7 located in the inner surface 61 is in front of the opening of the flow passage 7 located in the outer surface 62, when viewed in the direction of flow of the fluid in the discharge passage 5. Such a configuration is shown in FIG. 5 and FIG. 6. A negative inclination angle-45°≤β<0° means that the opening of the respective flow passage 7 located in the inner surface 61 is behind the opening of the flow passage 7 located in the outer surface 62, when viewed in the direction of flow of the fluid in the discharge passage 5.

Each of the flow passages 7 can be configured as a closed passage, e.g. a channel, extending inside the tongue 6. When configured as a closed flow passage 7, the flow passage 7 is completely closed on all sides or along its entire circumference, respectively, so that the inlet to the flow passage 7 and the outlet from the flow passage 7 are the sole openings through which a fluid can enter or leave the flow passage 7. A closed flow passage 7 can be configured, for example, as a bore drilled into the tongue.

FIG. 7 illustrates a perspective view of a first variant for the tongue 6 shown in FIG. 5 and FIG. 6. According to the first variant, the tongue 6 comprises a plurality of flow passages 7. The flow passages 7 are arranged in a first row FR extending in the axial direction A. The first row FR comprises two flow passages 7. Preferably, at most six flow passages 7 are arranged in the first row FR. Perpendicular to the first row FR and so also perpendicular to the axial direction A, a second row SR is extending, which comprises five flow passages 7. Preferably, a maximum of six flow passages 7 are arranged in the second row SR. The arrangement of the flow passages 7 is in the form of a matrix. Taking into consideration the preferred maximum of six flow passages 7 in the row FR and in the row SR, the preferred maximum size of the matrix is a 6×6 matrix.

It has to be noted that in other embodiments of the tongue 6, there is provided only the first row FR of flow passages 7 or only the second row SR of the flow passages. Furthermore, in still other embodiments, the number of flow passages 7 arranged in the first row FR is different from the number of flow passages in the second row SR. In addition, it has to be noted that it is not necessary that the flow passages 7 in the first row FR are aligned (regarding the axial direction A). Also, it is not necessary that the flow passages 7 of the second row are aligned.

FIG. 8 illustrates a schematic view on a second variant for the tongue 6. In the second variant the flow passages 7 are configured as open flow passages 7, preferably as grooves, which can be produced, for example, by machining such as milling. An open flow passage 7 designates a flow passage 7, which is not limited by a wall in a direction vertical to its main direction of flow, thus in a direction vertical to its longitudinal extension, but it is open. The open flow passage 7 has, for example, an U-shaped or a V-shaped profile. Regarding the flow passages 7 configured as open flow passages 7 it is preferred, that the open flow passages 7 are all arranged in the upper edge 64 delimiting the tongue 6 with respect to the axial direction A.

The second variant comprises two open flow passages 7, wherein the number of two flow passages 7 has to be understood as an example.

In other embodiments of the tongue 6, the tongue 6 comprises both one or more flow passages 7 configured as closed flow passages 7, and one or more flow passages 7 configured as open flow passages 7.

What is claimed is:

1. A centrifugal pump for conveying a fluid, comprising:
a pump casing having a central axis defining an axial direction;
a pump chamber;
an impeller arranged within the pump chamber and configured to rotate about the axial direction;
a discharge passage to discharge the fluid from the pump chamber; and
a tongue configured to guide the fluid to the discharge passage, the tongue comprising an inner surface facing the central axis, an outer surface facing away from the central axis, a leading edge joining the inner surface and the outer surface, and a flow passage extending from the inner surface through the tongue to the outer surface.

2. The centrifugal pump in accordance with claim 1, wherein the tongue is one of a plurality of tongues and the discharge passage is one of a plurality of discharge passages, and the pump casing comprises the plurality of tongues and the plurality of discharge passages, each tongue of the plurality of tongues is configured to guide the fluid in one discharge passage of the plurality discharge passages, and the flow passage is a one of a plurality of flow passages, each tongue of the plurality of tongues comprises at least one flow passage of the plurality of flow passages extending from the inner surface through the tongue to the outer surface of a respective tongue.

3. The centrifugal pump in accordance with claim 1, wherein the pump chamber is a volute chamber.

4. The centrifugal pump in accordance with claim 2, wherein the pump casing comprises a diffuser surrounding the pump chamber and has a plurality of stationary diffuser vanes, each stationary diffuser of the plurality if stationary diffuser vanes comprises one of the plurality of tongues to direct the fluid in one discharge passages of the plurality if discharge passages.

5. The centrifugal pump in accordance with claim 1, wherein a flow passage is one of a plurality of a flow passages, each flow passage of plurality of a flow passages extending from the inner surface through the tongue to the outer surface of the tongue.

6. The centrifugal pump in accordance with claim 5, wherein the discharge passage has an entrance area, which is the cross sectional area of the discharge passage at the leading edge of the tongue delimiting the discharge passage, and a total flow cross-section of all the plurality of flow passages in the tongue is at least 8% and at most 45% of the entrance area.

7. The centrifugal pump in accordance with claim 5, wherein all the plurality of flow passages are arranged in an angular region which is delimited by a leading edge tangent from the central axis to the leading edge and a straight borderline from the central axis to the tongue, the leading edge tangent and the borderline include an angle from 2° to 20°.

8. The centrifugal pump in accordance with claim 7, wherein each flow passage of the plurality f flow passages is a straight passage obliquely extending with respect to the leading edge tangent of the respective tongue.

9. The centrifugal pump in accordance with claim 1, wherein the flow passage defines an inclination angle between the flow passage and the inner surface of the tongue at a location, where a distance of the inner surface from the central axis is minimal, and the inclination angle is between −45° and 45°.

10. The centrifugal pump in accordance with claim 1, wherein the flow passage is a closed passage extending inside the tongue.

11. The centrifugal pump in accordance with claim 1, wherein the flow passage is an open passage.

12. The centrifugal pump in accordance with claim 1, wherein the flow passage is one flow passage of a plurality of flow passages arranged in a first row extending in the axial direction, and the first row comprises at most six flow passages of the plurality of flow passages.

13. The centrifugal pump in accordance with claim 12, wherein at least two flow passages are arranged in a second row extending perpendicular to the axial direction, and the second row comprises at most six flow passages of the plurality of flow passages.

14. The centrifugal pump in accordance with claim 1, wherein the flow passage is one of a plurality of flow passages, and the plurality of flow passages are arranged in a matrix.

15. The centrifugal pump in accordance with claim 1, wherein the flow passage is a groove.
